(19) United States
(12) Patent Application Publication
(10) Pub. No.: US 2008/0030992 A1
(43) Pub. Date: Feb. 7, 2008

(54) Lighting decoration

(76) Inventor: Wan-Chu Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/497,321

(22) Filed: Aug. 2, 2006

(51) Int. Cl. F21S 13/14

(52) U.S. Cl. 362/252

(57) ABSTRACT

The invention relates to a lighting decoration, which includes two symmetrical transparent shells to form a single body being connected with a support. The decoration is provided with several condensing boards while the shells are formed with preset figures having several relating independent areas. Each condensing board is provided with at least one lighting object nearby. Under control of the lighting objects, the decoration can display various lighting outlooks brightly and clearly that obtains the best decorative effect.

### BACKGROUND OF THE INVENTION

A decoration using lighting object in its transparent shell to display a specific figure of the shell is common in prior art. Such decoration usually has the lighting object fix in the shell simply. When the lighting object is lightened, it emits rays outward and the preset figure on the shell is shown. It will be found that the lighting effect is very poor since the ray of the lighting object is in all directions that the whole shell is lightened and the preset figure will be vague and not clear.

The present invention is to provide a lighting decoration, which can display clear decorative figure being preset of its shell to obtain improvement and utilization. Now, accompanying with the following drawings, the character of the present invention will be described here and after.

### BRIEF DESCRIPTION OF THE DRAWINGS

FIG. 1 is a perspective view showing a first embodiment of the lighting decoration according to the present invention.

FIG. 2 is an exploded perspective view of FIG. 1.

FIG. 3 is an exploded perspective view relating to FIG. 2 showing another side of top shell.

FIG. 4 is a cross-sectional plan view of FIG. 1.

FIG. 5 is an exploded perspective view showing a second embodiment of the lighting decoration according to the present invention.

FIG. 6 is an assembled cross-sectional plan view of FIG. 1.

FIG. 7 is an exploded perspective view showing a third embodiment of the lighting decoration according to the present invention.

FIG. 8 to 11 are perspective views showing various lighting outlooks of the lighting decoration according to the present invention.

### DETAILED DESCRIPTION OF THE PREFERRED EMBODIMENT

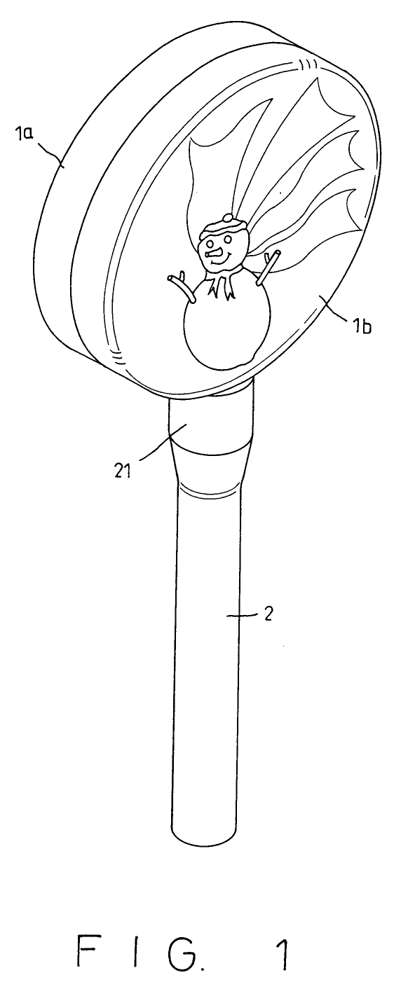

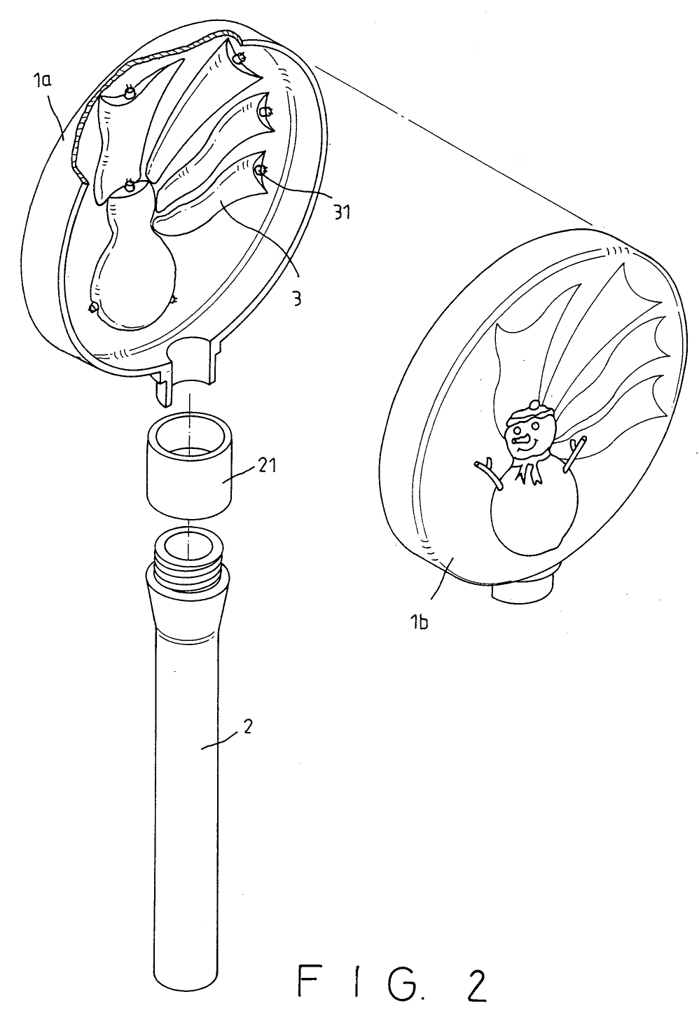

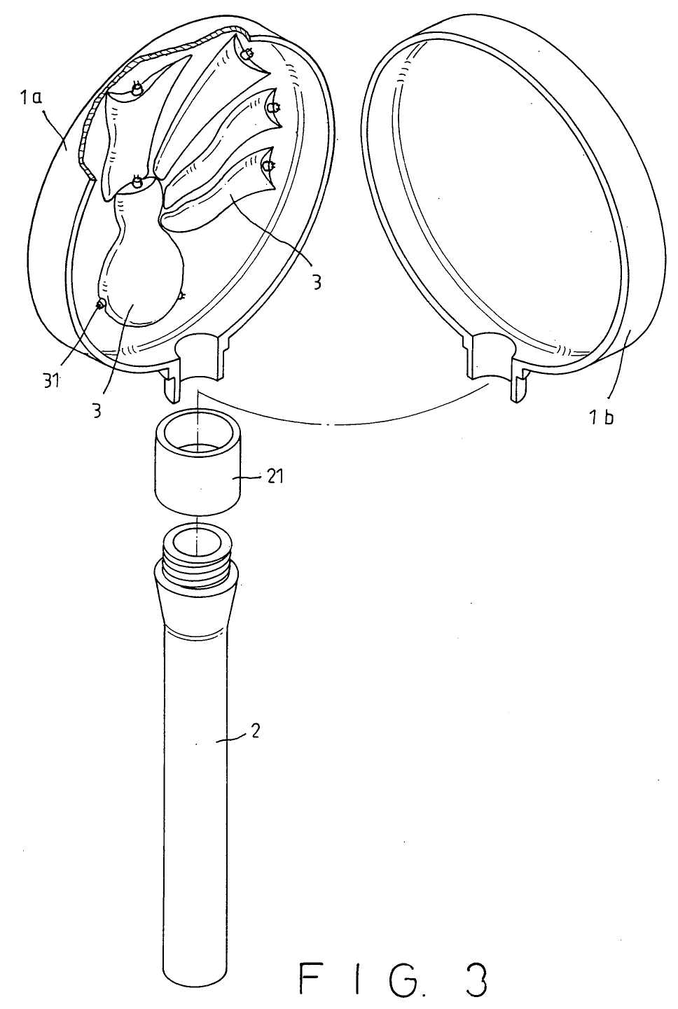

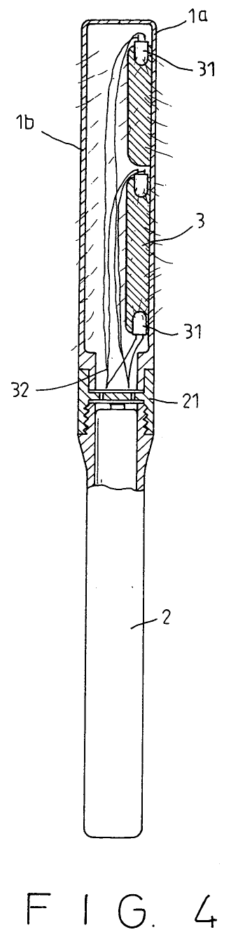

Referring to FIG. 1 to 4, the present invention relates to a lighting decoration, which includes two symmetrical shells (1a), (1b). The two shells can be formed with any facial specific figure having several independent areas. A ring (21) is used to connect two shells as a single object. A support (2) also connects with the ring (21) and is capable of receiving power supply and IC board therein. A character of the present invention is to provide several condensing boards (3) in the shells (1a), (1b). Each condensing board (3) is fixed relating to an independent area on the shell and is connected with at least one lighting object (31), which connects with electric wires (32) extending to IC board and power supply.

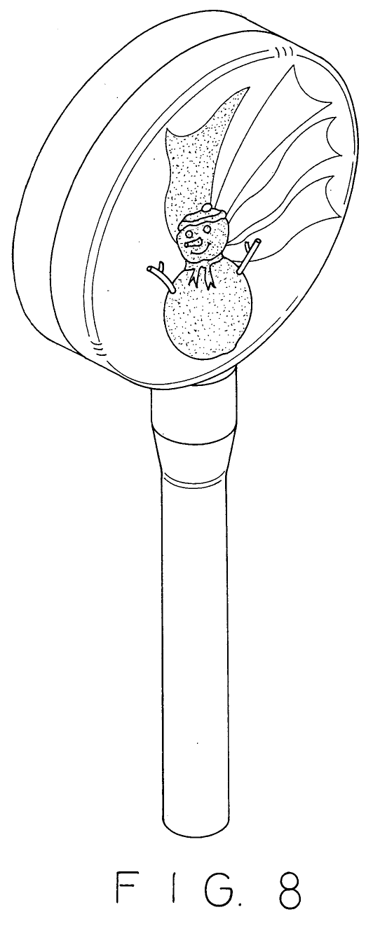

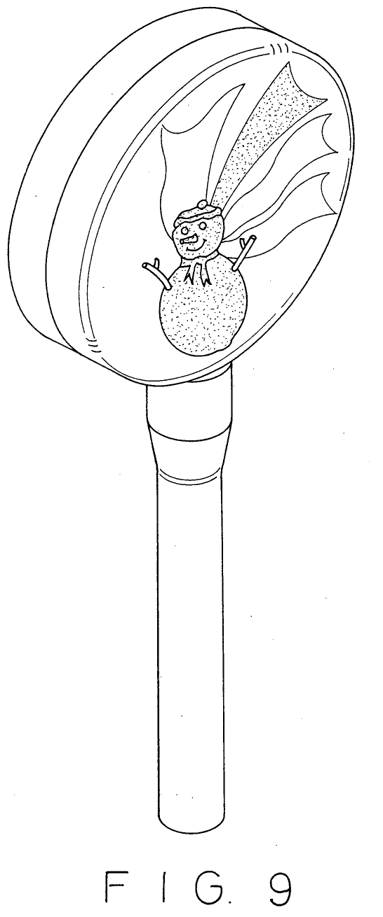

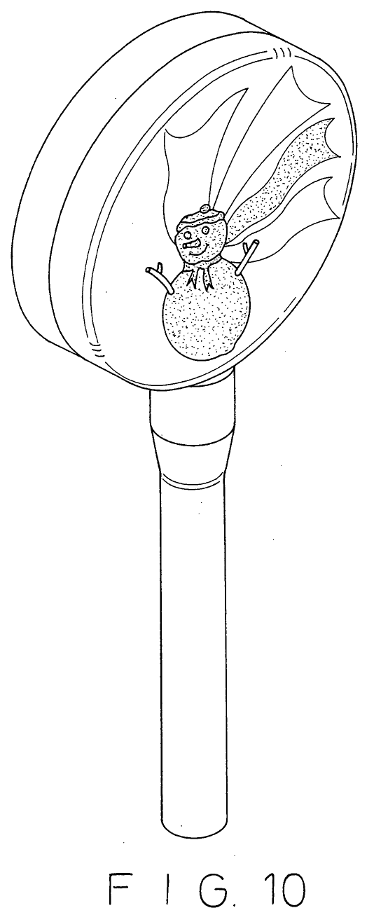

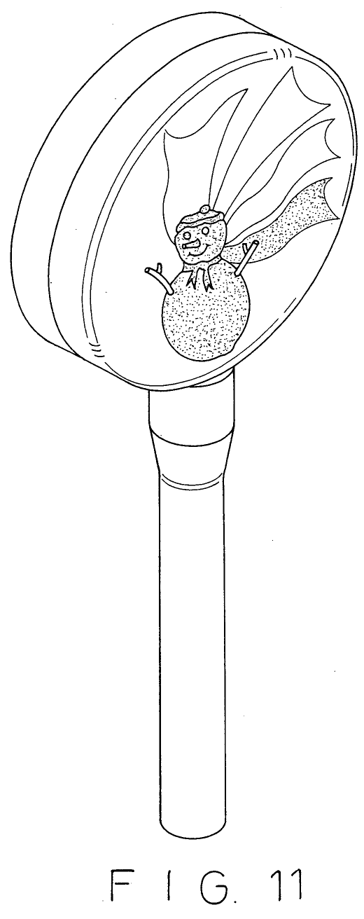

In use, each lighting object (31) emits rays, which will be gathered in a relating condensing board (3) and then emitted outward almost through the relating independent area. If only one lighting object (31) is lightened, the relating independent area will be very bright and clear on the whole surface of the shell. Under suitable control of the IC board, when the lighting objects are lightened in serial, the relating independent areas on the shells are lightened in serial respectively. As shown in FIG. 8 to 11, the lighting decoration of the present invention can thus display various outlooks as changing of the lighting objects like a snowman having a swinging scarf that obviously obtains perfect decorative effect.

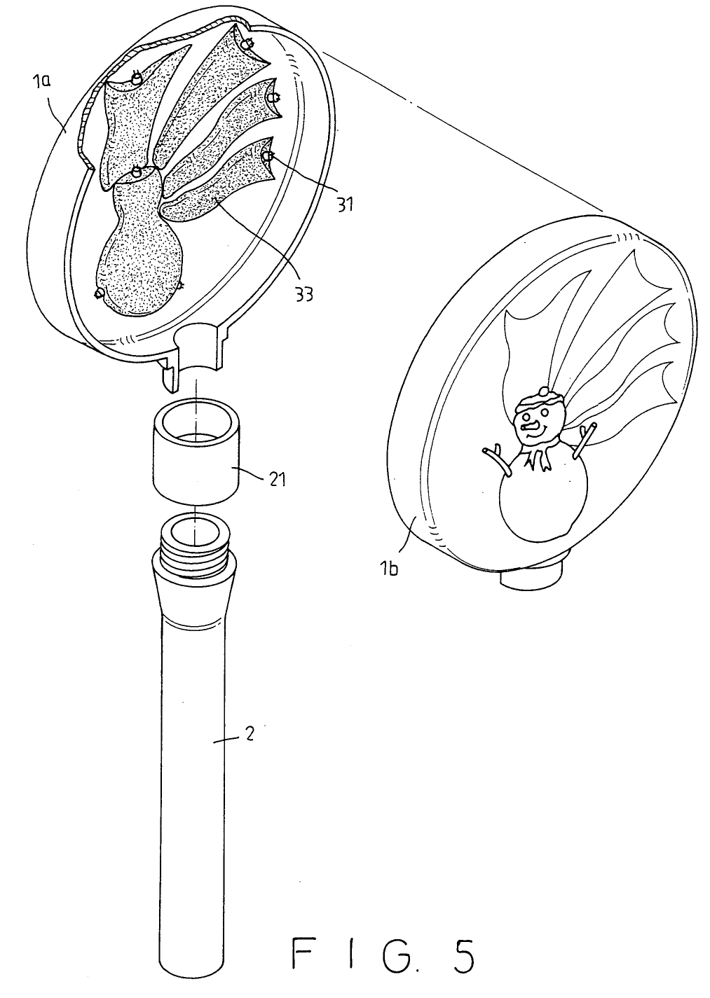

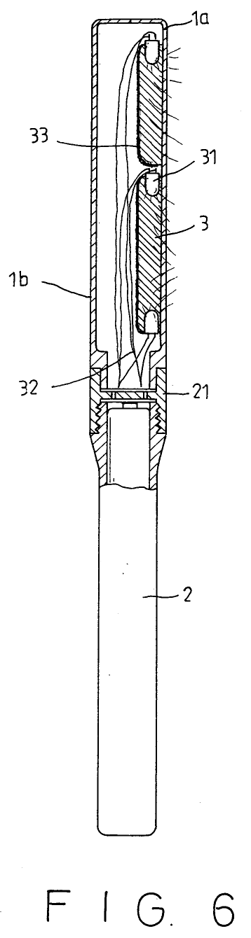

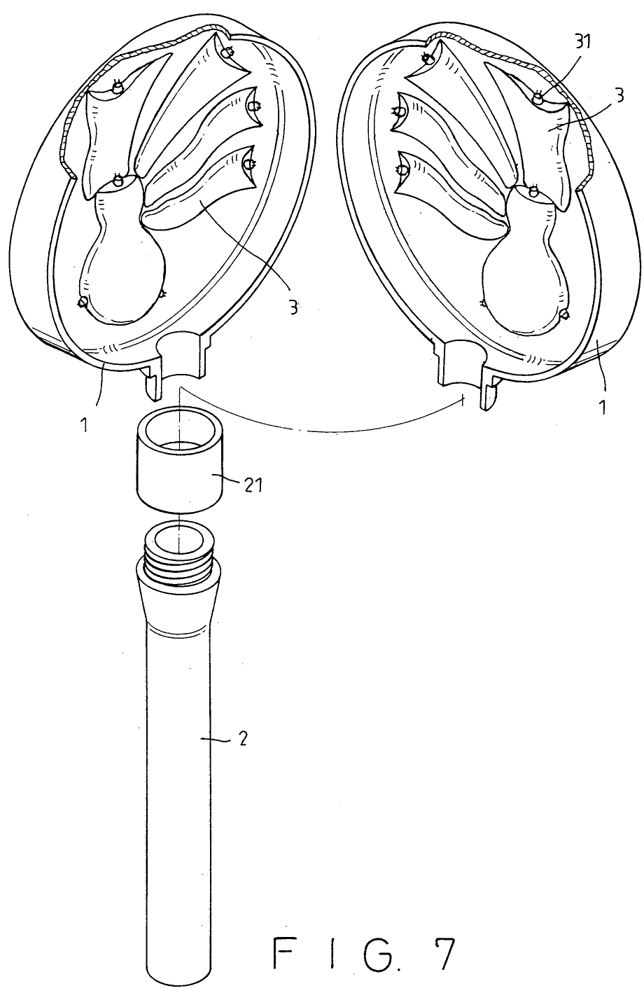

It is known that the above embodiment is only exemplary. There are possibly modified embodiments under the same merit of this application. Such as shown in FIG. 5 and 6, the condensing board (3) is coated with a reflecting film (33) on one side. Hence, the condensing board (3) can only emit gathering rays to one direction, such as the shell (1a), that will show a better lighting effect thereon. Furthermore, in order to obtain enough lighting rays on both shells (1a) and (1b) of the decoration, the present invention are capable of providing two sets of the condensing boards (3) in the shells, as shown in FIG. 7. This reaches the brightest lighting purpose on both sides of the decoration.

Hence, the present invention obviously obtains improvement and should be allowed for a patent.

I claim:

1. A lighting decoration including two symmetrical shells being formed with facial specific figure having several independent areas, a ring used to connect two shells as a single object, and a support (2) connected with the ring and being capable of receiving power supply and IC board therein; the character is to provide several condensing boards in the shells, each condensing board fixed relating to an independent area on the shell and connected with at least one lighting object, which connects with electric wires extending to IC board and power supply.

2. The lighting decoration as claimed in claim 1, wherein the condensing board being coated with a reflecting film on one side that the rays emit only through the other side.

3. The lighting decoration as claimed in claim 1, wherein the decoration having two sets of the condensing boards fixed therein.
